(19) United States
(12) Patent Application Publication
(10) Pub. No.: US 2011/0173571 A1
(43) Pub. Date: Jul. 14, 2011

(54) Graphical User Interface Guide

(76) Inventors: Maryamossadat Nematollahi Mahani, Lawrence, KS (US); John G. Milanski, Louisville, CO (US)

(21) Appl. No.: 12/686,570

(22) Filed: Jan. 13, 2010

(51) Int. Cl. G06F 3/048

(52) U.S. Cl. 715/841; 715/856

(57) ABSTRACT

A graphical user interface (GUI) is disclosed. The GUI includes a menu bar to display one or more menus, a GUI guide button and a GUI guide to simultaneously display commands in each of the one or more menus in response to a selection of the GUI guide button.

### FIELD OF THE INVENTION

The invention relates to the field of graphical user interfaces, and in particular, to providing assistance for navigating a graphical user interface.

### BACKGROUND

Modern computer systems implement graphical user interfaces (GUIs) to enable users to execute commands by selecting from amongst various menu options. Typically, a GUI is designed such that menus are displayed as text bars or icons linked in a navigation tree structure, where menus belonging to the same level are displayed simultaneously. Thus in order for a user to execute a specific command, the user must know the different function keys.

However, finding a function or feature in a complex user interface (such as Adobe Photoshop or a printer console) can be difficult since a complex system includes many features and settings. Moreover, names that are used to group or name features often do not assist in making the features easier to find because the names are either not memorable, too similar, or have no meaning anything to the particular user.

Further, menu navigation (e.g., the order in which screens are linked (or navigation tree) is fixed, and thus cannot be customized to make features easier to find. Finally, software designers often organize the GUI based on how frequently, how critical, and/or how many people use each function. Nonetheless, it is very difficult for the designers to find out if their guesses are correct based on actual use.

Accordingly, a GUI guide to enable function discovery is desired.

### SUMMARY

In one embodiment a graphical user interface (GUI) is disclosed. The GUI includes a menu bar to display one or more menus, a GUI guide button with the functionality of simultaneously displaying commands in each of the one or more menus in response to a selection of the GUI guide button.

In another embodiment, a computer generated method disclosed. The method includes displaying a menu bar within a GUI to display one or menus, displaying a GUI guide button and displaying a GUI guide having a simultaneous display of commands in each of the one or more menus in response to a selection of the GUI guide button

In a further embodiment a computer system is disclosed including a memory to store a printer driver program, a processor, coupled to the memory, to execute the printing product and a display device to display a GUI upon the processor executing the printing product. The GUI includes a menu bar to display one or menus and a GUI guide button that when selected causes commands in each of the one or more menus to be simultaneously displayed as a GUI guide.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIGS. 2A-2D are screen shots of various embodiments of a GUI; and

FIG. 3 illustrates one embodiment of a computer system.

### DETAILED DESCRIPTION

A GUI guide is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

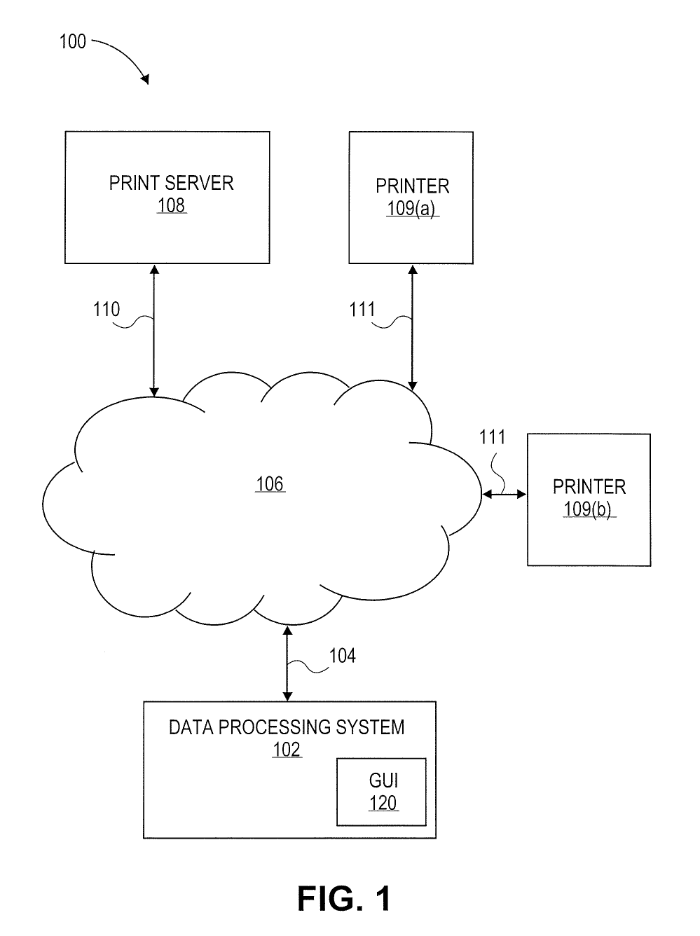

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In a further embodiment, data processing system 102 includes and employs the Windows operating system, or other operating system, and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

In one embodiment, a print application at data processing system 102 allows a user to select the desired print server 108 and submit requests for service requests to printer 109 via print server 108 over network 106. Although described as separate entities, other embodiments may include print server 108 being incorporated in one or more of the printers 109. However in other embodiments, the print server and printer may be physically separate entities. Therefore, the data processing system network depicted in FIG. 1 is selected for the purposes of explaining and illustrating the present invention and is not intended to imply architectural limitations. Further, those skilled in the art will recognize that various additional components may be utilized in conjunction with the present invention.

According to one embodiment, print server 108 implements a printing software product that manages the printing of documents from data processing system 102 and one or more of printers 109. In other embodiments, the printing software product manages printing of documents from multiple data processing systems 102 to the one or more printers 109.

According to one embodiment, the printing software product may be implemented using either InfoPrint Manager (IPM) or InfoPrint ProcessDirector (IPPD), although other types of printing software may be used instead. In a further embodiment, the print application at data processing system 102 interacts with the printing software product to provide for efficient transmission of print jobs.

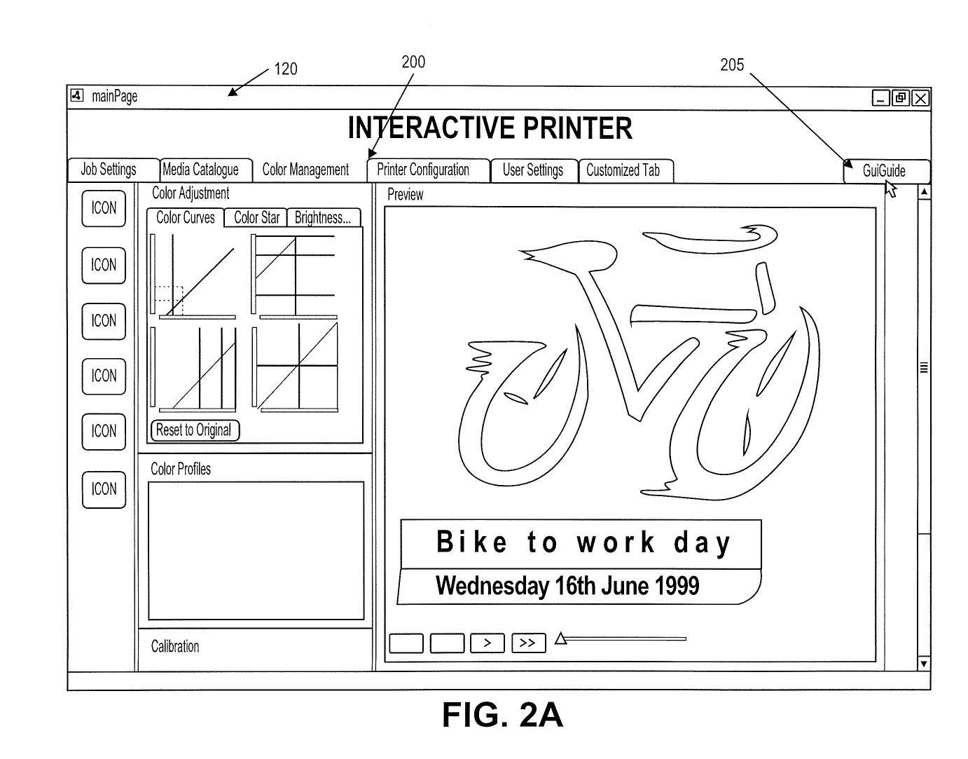

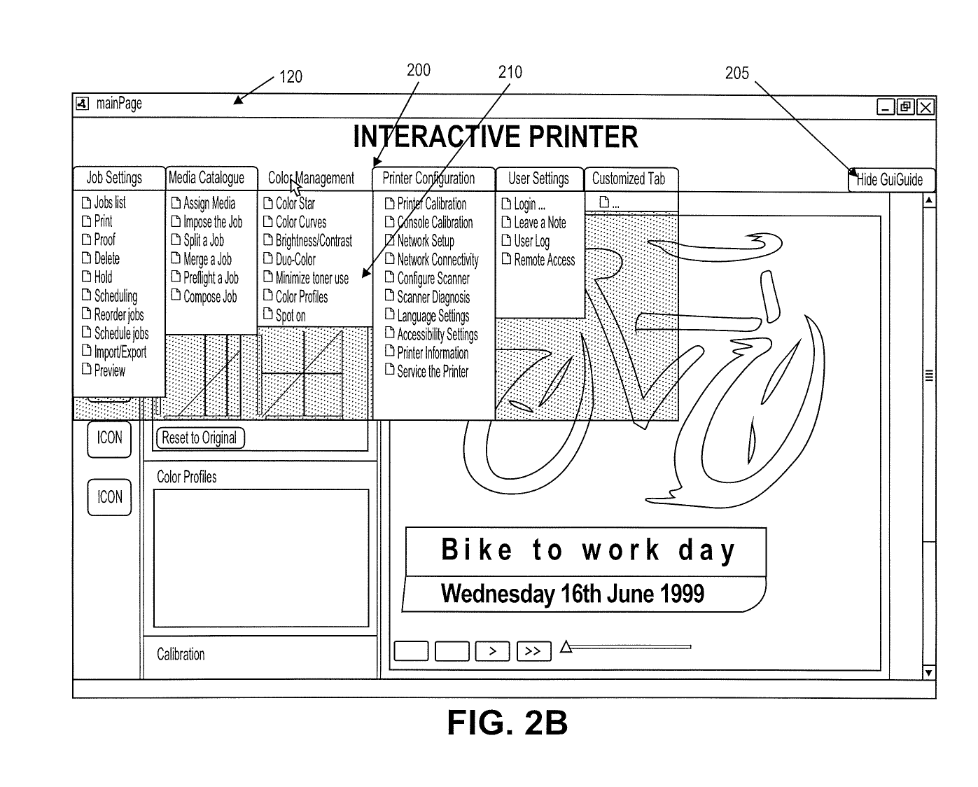

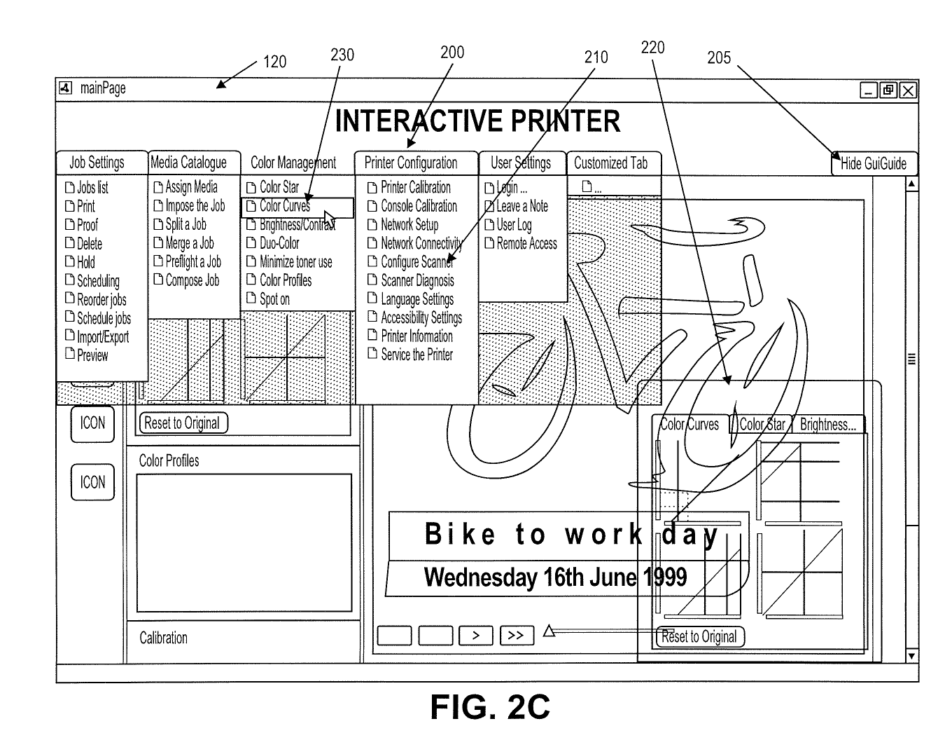

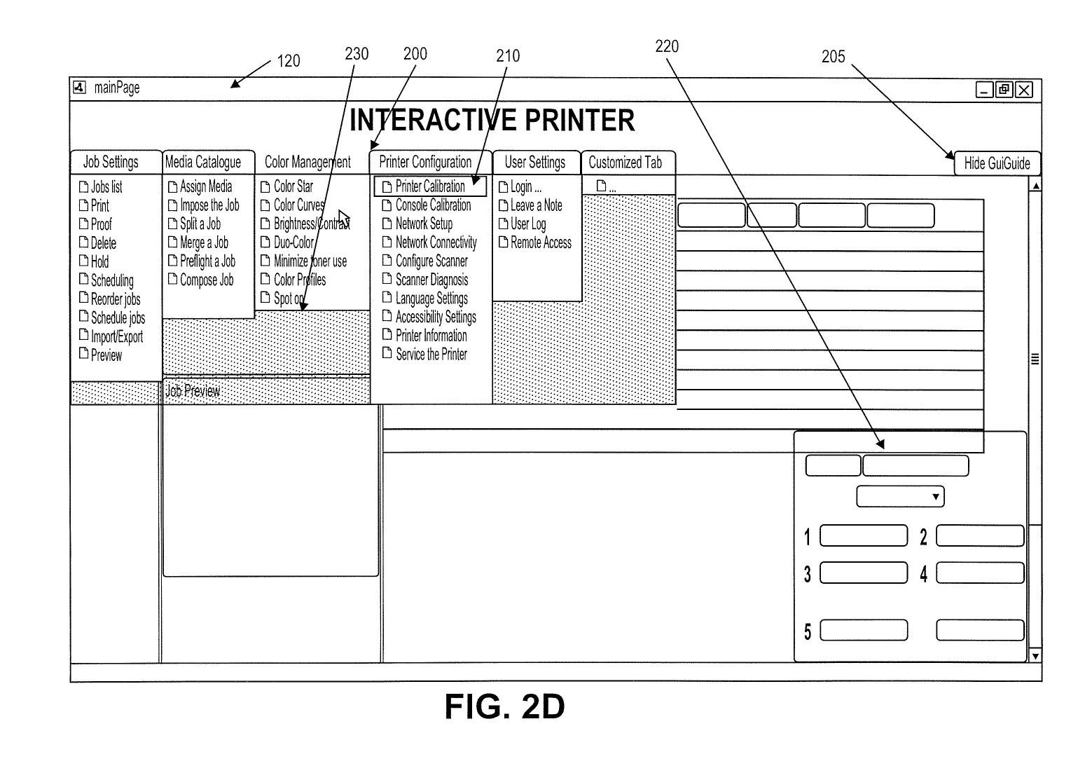

In one embodiment, the printing software product includes a graphical user interface (GUI) 120 accessible at a data processing system 102 that enables a system administrator (or operator) to interact with the printing software product and print application. FIG. 2A illustrates a screen shot of one embodiment of GUI 120.

As shown in FIG. 2A, GUI 120 includes a horizontal menu bar 200 having menus (e.g. Job Settings, Media Catalog, Color Management, etc.). Each menu includes various menu commands associated with respective application functions. Menu bar 200 reduces the number of features that a user has to scan in order to find a desired feature by grouping similar functions. However if a word used for a menu is unclear, a novice user may have difficulty finding a function in GUI 120. Another problem with menu bar 200 is that the user can only see one menu at a time.

According to one embodiment, GUI 120 includes a GUI Guide to assist a user in quickly finding a function by simultaneously displaying all of the functions available in each menu in menu bar 200. In such an embodiment, GUI Guide is activated by selecting a GUIGuide component (or button) 205 in GUI 120. Selecting GUIGuide button 205 forces all menus on GUI 120 to display their respective content to the user at the same time. Thus, the user does not have to go through several selections (or “clicks”) to open different parts of the application one at a time and look for the desired component. Further, simultaneously displaying menu commands prevents the user from having to scroll through a multitude of help text to find a desired component.

FIG. 2B illustrates a screen shot of one embodiment of GUI 120 after GUI Guide button 205 has been selected and a GUI Guide 210 is opened. As shown in FIG. 2B, GUI Guide 210 features a listing of every feature in each menu. For example, the Color Management menu lists Color Star, Color Curve, Brightness, Contrast, etc. In one embodiment, GUI Guide 210 may be hidden by again selecting button 205, which displays “Hide GUIGuide” whenever GUI Guide 210 is opened.

In a further embodiment, a screen for the application function corresponding to a menu command is shown in the bottom right corner of GUI 120 window whenever the user “rolls-over” (e.g., moves their mouse over a menu command/feature without clicking) a menu command. Additionally, an outline of where that screen is displayed where it actually would appear on GUI 120 if the user were to select the command.

FIG. 2C is a screen shot of an embodiment of GUI 120 illustrating the roll-over feature. In this embodiment the user has rolled over the color curve function, resulting in windows 220 and 230 being displayed. Window 220 displays the content of the Color Curve function, while window 230 displays the location at which the Color Curve function would be displayed once selected. FIG. 2D illustrates a screen shot of another embodiment of the roll-over feature in GUI 120, where the user has rolled over the printer calibration function, resulting in windows 220 and 230 being displayed.

If the user rolls-over a menu command, GUI 120 displays an outline of that menu command, thus showing where each menu command is to be located within GUI 120. This feature provides the user with a direct mapping between the commands under the menus with their actual location on GUI 120. In yet a further embodiment, the commands under each menu are dynamic such that the order of the commands may be changed by the user changing their position on GUI 120 through customization (e.g., drag-n-drop or resizing windows). For example, for a menu that includes several commands, the command at the top of the menu will be on top of the list. If that command is repositioned to the bottom of the menu, the command will go to the bottom of the menu list.

In another embodiment, the order of menu commands may change as a reflection as to how each command is used. In such an embodiment, the menu order may be changed based on frequency of use, criticality, and number of users of a particular feature. For example, a set of three buttons including frequency, criticality, and number of users could be placed in the GUI 120 along with the menus. Whenever each criteria button is rolled-over, the menu commands may rearrange themselves by the particular criteria (e.g. most frequently used move to the top of the list). In one embodiment, frequency is determined by the application simply keeping track of how often a command has been clicked on. Criticality may be determined by the number of times a command has been clicked on after a certain system error occurred. The number of people may be determined by counting the number of different user logins that have used that command.

In yet another embodiment, the commands in each menu are customizable such that the commands can be drag-and-dropped from one menu to another. Further, the name or icon used for each command may also be changed.

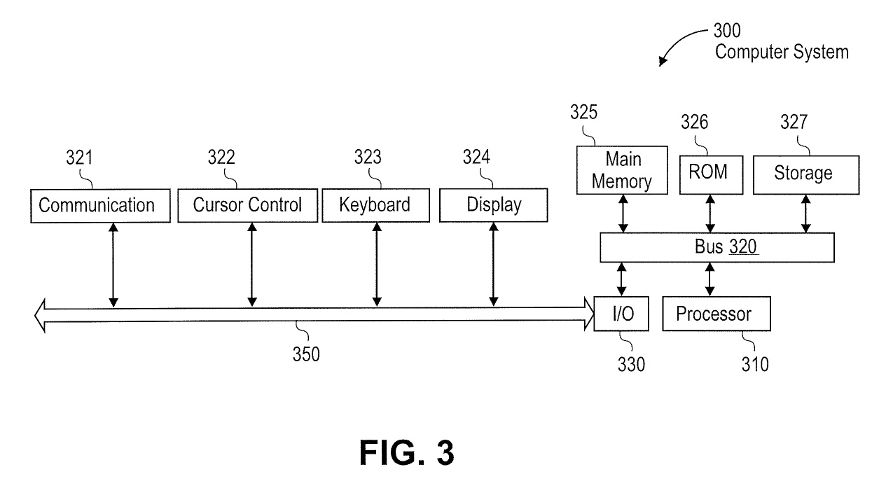

FIG. 3 illustrates a computer system 300 on which data processing system 102 and/or server 108 may be implemented. Computer system 300 includes a system bus 320 for communicating information, and a processor 310 coupled to bus 320 for processing information.

Computer system 300 further comprises a random access memory (RAM) or other dynamic storage device 325 (referred to herein as main memory), coupled to bus 320 for storing information and instructions to be executed by processor 310. Main memory 325 also may be used for storing temporary variables or other intermediate information during execution of instructions by processor 310. Computer system 300 also may include a read only memory (ROM) and or other static storage device 326 coupled to bus 320 for storing static information and instructions used by processor 310.

A data storage device 325 such as a magnetic disk or optical disc and its corresponding drive may also be coupled to computer system 300 for storing information and instructions. Computer system 300 can also be coupled to a second I/O bus 350 via an I/O interface 330. A plurality of I/O devices may be coupled to I/O bus 350, including a display device 324, an input device (e.g., an alphanumeric input device 323 and or a cursor control device 322). The communication device 321 is for accessing other computers (servers or clients). The communication device 321 may comprise a modem, a network interface card, or other well-known interface device, such as those used for coupling to Ethernet, token ring, or other types of networks.

The above-described GUI Guide enables a user to find features faster since the interface navigation is easier to search, comprehensive and customizable to enable automatic rearranging to correct designer mistakes.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer system comprising:
a memory to store a printer driver program;
a processor, coupled to the memory, to execute the printing product; and
a display device to display a graphical user interface (GUI) upon the processor executing the printing product, the GUI having a menu bar to display one or more menus and a GUI guide button that when selected causes commands in each of the one or more menus to be simultaneously displayed as a GUI guide.

2. The computer system of claim 1 wherein a second selection of the GUI guide button closes the GUI guide.

3. The computer system of claim 1 further wherein a function associated with a command is displayed in the GUI upon the command being rolled over by a cursor.

4. The computer system of claim 3 wherein an outline of the function location within the GUI is displayed upon the command being rolled over by a cursor.

5. The computer system of claim 1 wherein an outline of each function location corresponding to commands in a menu are displayed in the GUI upon a menu being rolled over by a cursor.

6. The computer system of claim 1 wherein the order of commands in the GUI guide is customizable.

7. The computer system of claim 7 wherein a first command is moved by the cursor from a first menu in the GUI guide to a second menu.

8. The computer system of claim 6 wherein a first command in a menu is moved by the cursor above a second command.

9. The computer system of claim 1 wherein an order of commands in a menu is dynamically changed.

10. The computer system of claim 9 wherein the order of commands in the menu is changed based on one of: frequency of use, criticality, and number of users of the commands.

11. The computer system of claim 10 wherein GUI comprises:
a frequency button
a criticality button; and
a number of users button.

12. The computer system of claim 11 wherein a cursor rolling over one of the frequency, criticality or number of users buttons results in reordering of commands in a menu.

13. A computer generated method comprising:
displaying a menu bar within a graphical user interface (GUI) to display one or menus;
displaying a GUI guide button; and
displaying a GUI guide having a simultaneously display of commands in each of the one or more menus in response to a selection of the GUI guide button.

14. The method of claim 13 further comprising closing the GUI guide in response to a second selection of the GUI guide button.

15. The method of claim 13 further comprising displaying a function associated with a command in response to the command being rolled over by a cursor in the GUI guide.

16. The method of claim 15 further comprising displaying an outline of the function location associated within the GUI in response to the command being rolled over by a cursor in the GUI guide.

17. The method of claim 13 further comprising displaying an outline of each function location corresponding to commands in a menu in response to the menu being rolled over by a cursor.

18. The method of claim 13 wherein the location of commands in the GUI guide is customizable.

19. The method of claim 18 further comprising moving a first command is moved by from a first menu in the GUI guide to a second menu.

20. The method of claim 17 further comprising moving a first command in a menu above a second command.

21. The method of claim 13 further comprising dynamically changing an order of commands in a menu.

22. The method of claim 21 further comprising changing the order of commands in the menu based on one of: frequency of use, criticality, and number of users of the commands.

23. The method of claim 22 further comprising reordering commands in a menu in response to a cursor rolling over one of the frequency, criticality or number of users buttons.

24. A graphical user interface (GUI) comprising:
a menu bar to display one or menus;
a GUI guide button; and
a GUI guide to simultaneously display commands in each of the one or more menus in response to a selection of the GUI guide button.

25. The GUI of claim 24 further comprising a window displaying a function associated with a command upon the command being rolled over by a cursor.

26. The GUI of claim 25 further comprising a window displaying an outline of the function location upon the command being rolled over by a cursor.

27. The GUI of claim 24 further comprising windows displaying outlines of each function location corresponding to commands in a menu upon a menu being rolled over by a cursor.

28. The GUI of claim 24 further comprising:
a frequency button
a criticality button; and
a number of users button.
